(19) United States
(12) Patent Application Publication
(10) Pub. No.: US 2007/0061233 A1
(43) Pub. Date: Mar. 15, 2007

(54) Method for securities trading using variable product orders

(76) Inventors: Vladan D. Jovanovic, Middlesex (GB); Veselin Vesko Stanic, London (GB); Richard S. Lane, London (GB); Adnan Beganovic, London (GB)

Correspondence Address: BROMBERG & SUNSTEIN LLP, 125 SUMMER STREET, BOSTON, MA, 02110-1618, US

(21) Appl. No.: 11/227,444

(22) Filed: Sep. 15, 2005

(51) Int. Cl. G06Q 40/00

(52) U.S. Cl. 705/36 R

(57) ABSTRACT

A method for trading securities. A trader generates a variable derivative product order that identifies at least a derivative product, an underlying financial product or instrument, a pricing formula, and values of price determination variables needed by the pricing formula to establish a price for the derivative. The variable product order is transmitted electronically to an exchange. The exchange calculates the offered price of the derivative using a value of the underlying product and publishes offers to potential traders. The offered price is recalculated as the value of the underlying products changes and republished to potential traders. Trades may then be executed based on the offered prices. Hedging trades may be executed in combination with trades made based on the variable derivative product orders.

### TECHNICAL FIELD

The present invention relates to methods for electronic trading of financial securities, and, in particular to trading derivatives using variable product order pricing

### BACKGROUND ART

Any financial instrument whose price is based on or derived from the price of another financial instrument (the “underlying product”) is called a derivative or option. For example, a put option is a contract whereby the put buyer acquires the right, but not the obligation, to sell a specified stock or commodity at a predetermined price on or before a predetermined date. Similarly, a call option gives the purchaser of the option the ability, but not the obligation, to buy a specified financial instrument at a specified price up to a given date. Another example of a derivative is a future.

Derivatives are frequently priced by traders using a theoretical model, such as the Black/Scholes model. These models incorporate calculations based on the price of the underlying product and a variety of variables, often denoted by Greek letters and called the “Greeks”, such as delta, gamma, theta and kappa (a.k.a. “vega”):

Delta is the rate of change of fair value of an option with respect to the change in price of the underlying product.

Gamma is the rate of change of an option's delta with respect to underlying price. Thus, Gamma is the second derivative of option value with respect to underlying price

Theta is the rate at which an option loses value as time to maturity decreases.

Kappa is the sensitivity of an option's value to a change in volatility.

It has become increasingly desirable to trade derivative products using computer systems attached to networks. Such methods can facilitate accuracy, speed and reduced costs in such trading. However, market makers in derivatives are at risk in such electronic trading because they may not be able to update their prices promptly as the price of the underlying product changes (often multiple times per second) due to transmission delays and bandwidth limitations in sending updates. Likewise, market makers are unable control their order risk by limiting volumes offered for sale as trades are executed. Therefore, an automated trading system that enables derivatives to be traded safely and transparently on-screen by all end-users is desirable.

### SUMMARY OF THE INVENTION

In an embodiment of the present invention, a user generates a variable derivative product order or multiple variable derivative product orders. A variable product order identifies at least a derivative product, an underlying product, a pricing formula, and values of price determination variables needed by the pricing formula to establish a price for the derivative product. The variable product order is then transmitted electronically to an exchange. The exchange may then calculate the offered price at any time using the value of the underlying product and the values of the price determination variables. The pricing formula may be selected from one or more pricing formulas maintained at the exchange or may be a formula transmitted by the user to the exchange, either as a separate transmission or transmitted together with the variable product order.

In another embodiment of the invention, the exchange receives variable product orders from a first plurality of users, and then calculates a current price for a variable product order based on the given pricing formula, price determination variables and updated prices of the underlying product. The exchange then transmits the current price of a derivative product identified in a variable product order to at least one user. Embodiments of the invention advantageously reduce the communication bandwidth needed from trader to exchange and reduce attendant delays: when the price of the underlying product changes, the exchange can update derivative prices without further information transfer from trader to exchange. Since the price of the underlying product may change many times per second, the reduction in bandwidth can be considerable. Further, a trader may safely quote prices with a variable product order secure in the knowledge that the offered price will move in step with the movement of the underlying product price.

In another embodiment of the invention, a method of hedging risks associated with purchase of a derivative product is provided. The method includes executing a variable product order at a match system; receiving risk data for the order; using a best efforts approach to locate a potential hedge transaction corresponding to the variable product order; comparing the potential hedge transaction to the risk data; and executing the potential hedge transaction when trading rules are met.

In another embodiment of the invention, a method of hedging risks associated with purchase of a derivative product is provided. The method includes receiving a variable product order at a match system; identifying a potential trade consistent with the product order; searching for a hedge product transaction corresponding to the potential trade; and executing the variable product order only when a suitable hedge transaction can be executed contemporaneously.

U.S. patent application publications nos. US 2004/0199450A1, US 2004/0199452A1 and US 2004/0199459A1, dated Oct. 7, 2004, describe embodiments of the present invention and are incorporated by reference herein in their entirety. Claims from these applications have been copied herein.

### BRIEF DESCRIPTION OF THE DRAWINGS

The foregoing features of the invention will be more readily understood by reference to the following detailed description, taken with reference to the accompanying drawings, in which:

FIG. 1A is a block diagram for a trading system according to an embodiment of the invention;

FIG. 1B shows a block diagram of a trading system according to another embodiment of the invention;

FIG. 2 is a flow diagram for a method of pricing derivatives using a variable pricing formula according to an embodiment of the invention;

FIG. 3 is a flow diagram for a method of trading using variable product orders and associated hedge transactions according to an embodiment of the invention;

FIG. 4 is a flow diagram illustrating an embodiment of the invention in which an exchange receives variable product orders and publishes prices based on the orders;

FIG. 5 is a flow diagram for a best efforts method of hedging risks associated with purchase of a derivative product according to an embodiment of the invention;

FIG. 6 is a flow diagram for processing an order for a derivative product considering risk thresholds, according to an embodiment of the invention;

FIG. 7 is a flow diagram for a method of trading large volumes of securities according to an embodiment of the invention;

FIG. 8 is a flow diagram for a method of selectively displaying requests for quotation to traders based on trader selected categories according to an embodiment of the invention;

FIG. 9 is a flow diagram for a method of entering an order for a user identified request for quotation according to an embodiment of the invention; and

FIG. 10 shows an event window for the embodiment of FIGS. 8 and 9.

### DETAILED DESCRIPTION OF SPECIFIC EMBODIMENTS

The present application is related to a United States patent application entitled “METHOD FOR TRADING SECURITIES”, attorney docket 2997/104, filed on even date herewith, which is incorporated by reference herein in its entirety.

Definitions. As used in this description and the accompanying claims, the following terms shall have the meanings indicated, unless the context otherwise requires:

A “variable product order” or “variable derivative product order” shall mean an offer to buy or sell a derivative product that identifies at least the derivative product, an underlying product, a pricing formula, and at least one price determination variable so that the offered price can be calculated at any time using the pricing formula, the current price of the underlying product and at least one price determination variable.

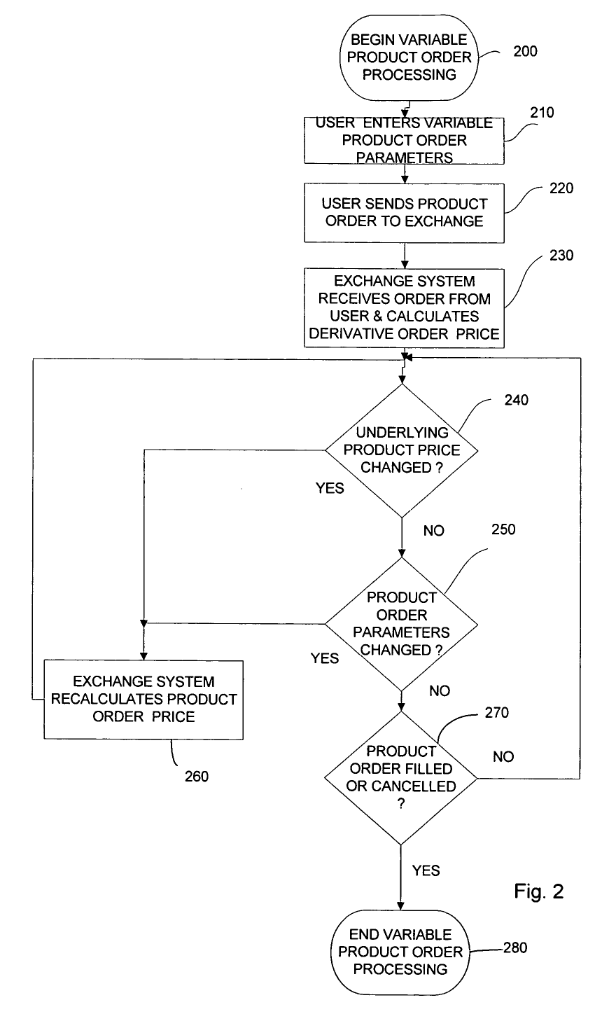

In a first embodiment of the present invention, as shown in FIG. 2, a user generates a variable derivative product order 200. The variable product order identifies 210 at least the derivative product, the underlying product, a pricing formula, and values of the price determination variables needed by the pricing formula to establish a price for the derivative. The variable product order contains the original price for the derivative product either implicitly (i.e., initial price can be calculated) or explicitly. The price determination variables may include any of the Greek variables, as described above, or any other variables for which the user and exchange have a common definition. The variable product order is transmitted electronically 220 to an exchange. The exchange receives the variable product order and then calculates 230 the offered price of the derivative using a current value of the underlying product, which typically will be the latest updated price, the pricing formula and values of the price determination variables. The calculations are performed by a computer processor. The pricing formula may be selected from one or more pricing formulas maintained at the exchange or may be a formula transmitted by the user to the exchange, either as a separate transmission or transmitted together with the variable product order.

For example, in an embodiment of the invention, the pricing formula may be a formula based on the Black/Scholes pricing model. One example of a price determination formula based on Black/Scholes is:

Change in price of the order=chgUnderlyingprice*delta+(1/2(chgUnderlyingpriceˆ2* gamma))where chgunderlyingprice is the change in price of the underlying product.

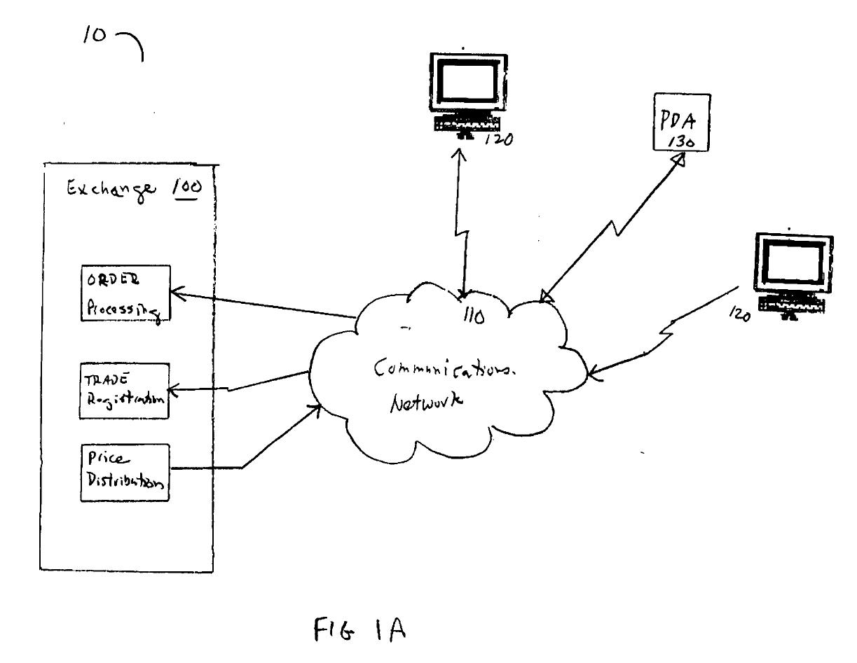

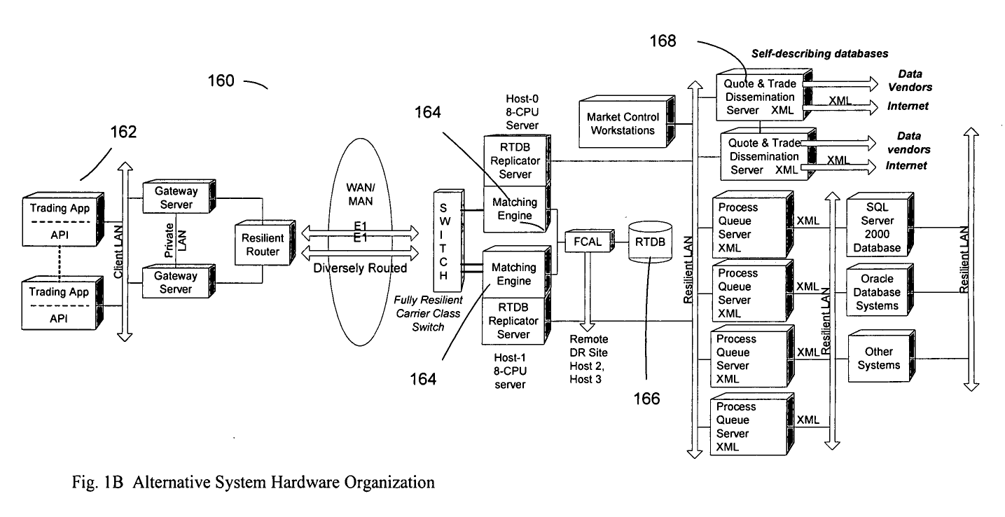

In embodiments of the invention, the user, who may also be referred to below as a “trader,” may communicate with an exchange, both for transmitting orders and receiving offers, by any of a variety of electronic means. For example, as shown in the system organization 10 of FIG. 1A, an exchange 100 receives incoming orders, including variable product order, and transmits offers, distributing at least current best offered prices, and effects trades. Communication from the exchange to traders is made via public or private communication systems 110 of any type known in the art. Such communication systems may include, without limitation, data networks as are known in the art, such as the internet, using both wired and wireless link-level and physical media, point-to-point communication means, such as the public telephone system, satellite links, a T1 line, a microwave link, a wire line or a radio link, etc. Traders may use any of the variety of computing devices known in the art to prepare orders and receive offers via the communication system 110 in the various embodiments of the invention. For example, a trader may use a desktop or notebook computer or workstation 120. Alternatively, the trader may use a personal digital assistant (“PDA”) 130 or a suitably equipped cell phone or any other device with a computer processor or any device that can communicate with a computer processor. Likewise, the exchange 100 will execute calculations and process data received from and transmitted to users in the various embodiments of the invention with any of the variety of computer processors and other electronic data processing equipment as are known in the art.

FIG. 1B shows another equipment system organization 160 according to an embodiment of the invention. Desktop and other trading applications 162 connect via cluster-configured local Gateway Servers and a resiliently configured router connected via diversely routed metropolitan area/wide area network connections to the exchange's fully resilient carrier-class entry point switch. The entry point switch connects in a resilient manner to the cluster-configured exchange hosts 164 via load-sharing multiple gigabit ports. The two primary site hosts connect via a fibre channel ‘switch’ (FCAL =Fibre Channel Arbitrated Loop) to the Real Time Data Base (“RTDB”) 166 and to the remote backup site containing the other two hosts comprising the cluster where the backup system's RTDB will be kept in step with the primary site RTDB. The cluster hosts may be implemented as multi-CPU configurations sufficient for the throughput required. More than one matching engine may operate in parallel, each dedicated to serving particular sets of markets so to distribute the load. The matching engines 164 receive, acknowledge and match the incoming orders against the market, report any matches to the order originators and broadcast the trade reports and new orders in the market to the gateways. The RTDB content can reflect the complete state of the entire market at any one time. The RTDB can be implemented using resilient technology, such as a hot-swap RAID 1 array). The RTDB Replicator processes can replicate the RTDB content onto the Backup Site RTDB and also on to a range of servers implementing the remaining exchange functionality, as indicated i.e. Clustered Quote and Trade Dissemination servers—serving Data Vendors and the Exchange Website with XML exchange feeds and historical data. Process Queue Servers—mapping the market updates into XML and supplying the updates to arrays of SQL and/or Oracle databases at a rate that they can absorb and still provide an interface for external systems such as Market Supervision, Trade Registration, Clearing and Settlement. These can be configured with 1-for-N backup and manually controlled fail-over.

Again referring to FIG. 2, in various embodiments of the invention, the exchange computer may update 240, 260 the price for the variable product order periodically based on the pricing formula and an updated price for the underlying product. In some embodiments of the invention, the pricing formula is a predetermined formula agreed upon between exchange and user. In other embodiments of the invention, the user may transmit a formula to the exchange as part of the variable product order. The user may transmit a change in the variable product order parameters to the exchange computer at any time prior to order execution and the exchange computer will update 250, 260 the order price based on the updated product order parameters and the current price of the underlying product. When the variable product order is filled or cancelled 270, processing completes 280. This embodiment of the invention advantageously reduces the communication bandwidth needed from trader to exchange and reduces attendant delays: when the price of the underlying product changes, the exchange can update derivative prices without further information transfer from trader to exchange. Since the price of the underlying product may change many times per second, the reduction in bandwidth can be considerable. Further, a trader may safely quote prices with a variable product order secure in the knowledge that the offered price will move in step with the movement of the underlying product price.

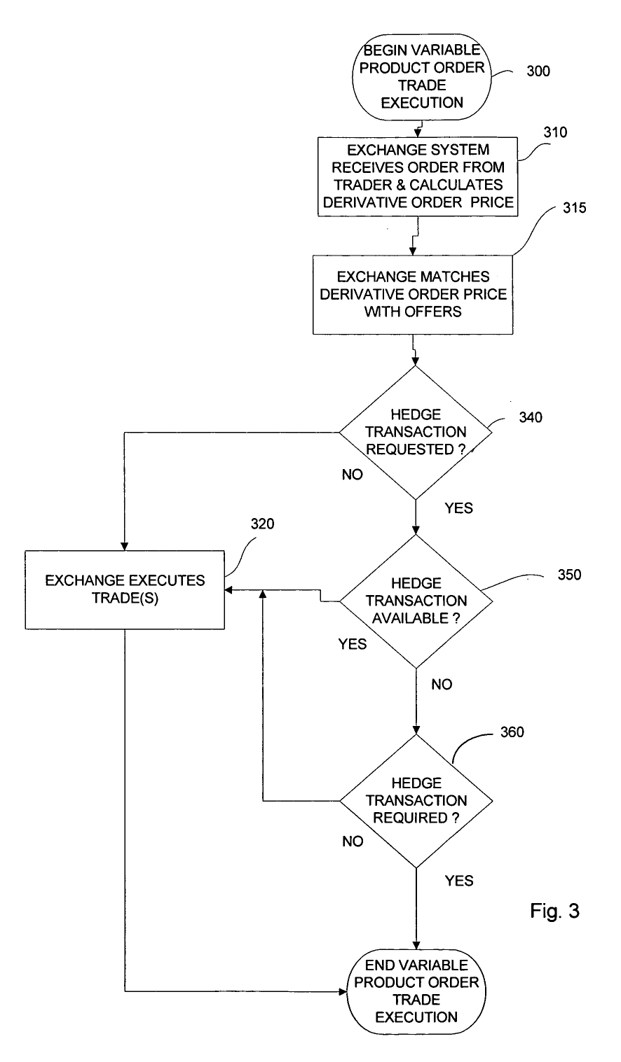

In a further embodiment 300 of the invention, as shown in FIG. 3, the exchange may execute a trade 320 based on the variable product order, after receiving the order and calculating an updated price based on the pricing formula 310, 315. In a further specific embodiment, the exchange may execute a hedge transaction 340, 350 at the time of the trade. The hedge transaction may include buying or selling the underlying product. In a specific embodiment of the invention, execution of the variable product order trade may be made contingent 360 on availability of a corresponding hedge transaction. Thus, when the exchange identifies a transaction for the derivative product, the transaction for the derivative product and the transaction for the corresponding hedge must be executed contemporaneously (“locked-in”) or neither transaction will be executed. Since the underlying product is identified in the variable product order, the variable product order identifies at least one hedge transaction implicitly or the variable product order may include an explicit specification of a hedge transaction.

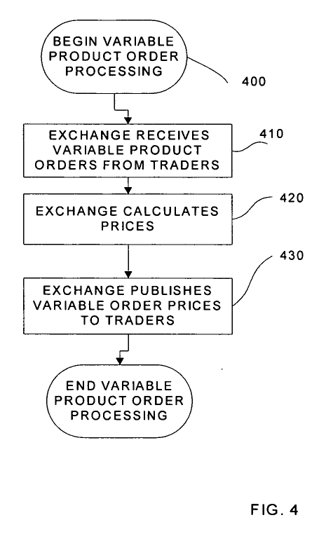

In another embodiment of the invention, as shown in FIG. 4, the exchange receives 400 variable product orders 410 from a first plurality of users, and then calculates 420 a current price for each variable product order based on the given pricing formula, price determination variables and updated prices of the underlying products. The exchange then transmits 430 the current price of each derivative identified in at least one variable product order to at least one user. The user may then respond by accepting the offered price causing a trade to be made. In a specific embodiment of the invention, the at least one user may be a member of the first plurality of users. In other embodiments, the exchange transmits updated prices according to the variable product order to users when the underlying product prices change or any other variables in the pricing formula change.

In another embodiment of the invention, a user prepares a variable product order and then transmits the variable product order to an exchange electronically as an offer to buy or sell a derivative product. The variable product order may include any of the Greeks as price determination variables, as well as other price determination variables.

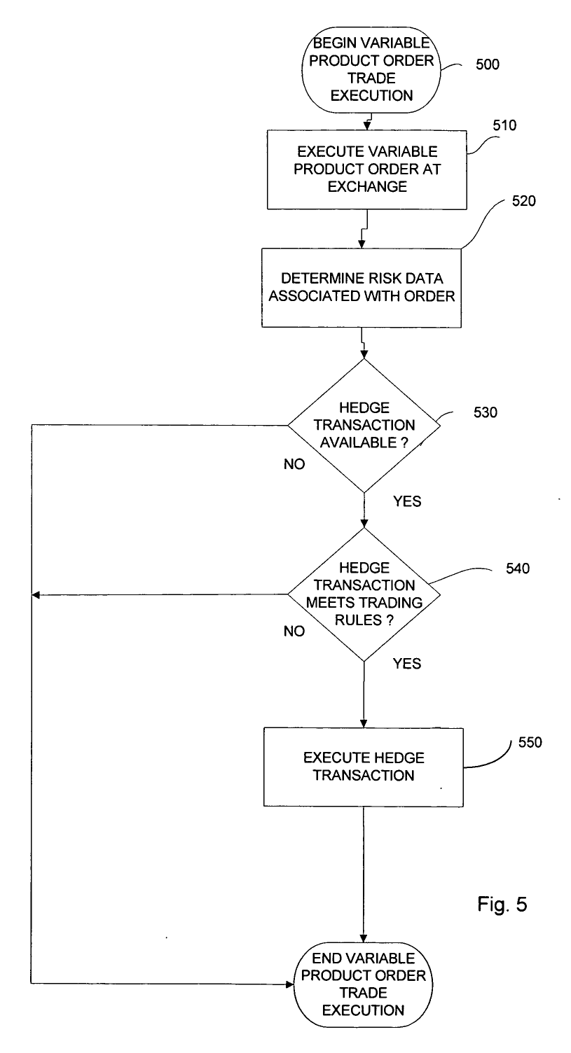

In another embodiment of the invention, as shown in FIG. 5, a method of hedging risks associated with purchase of a derivative product is provided. The method 500 includes executing a variable product order at a match system 510; receiving risk data for the order 520; using a best efforts approach to locate a potential hedge transaction corresponding to the variable product order 530; comparing the potential hedge transaction to the risk data 540 and executing the potential hedge transaction 550 when the trading rules are met. For example, the risk data for the order may include maximum and/or minimum delta and/or gamma values for the order. The risk data may be supplied with the variable product order or may be maintained in a database at the match system. The trading rule may establish a threshold value for the hedge transaction. For example: a trader may maintain quoting of 1000 per strike in a multiple of orders and could script that hedging needs could be executed whenever a delta of 100 or more is exceeded. The potential hedge transaction is executed only if the hedge transaction meets or exceeds the threshold value in the trading rule.

In a specific embodiment of the invention, the method of hedging risks includes calculating a price from the variable product order. In some embodiments, the price determination variables in the variable product order include delta and gamma. In another embodiment, the derivative product comprises an options contract and the hedge product comprises a futures contract. In an embodiment of the invention, the derivative transaction may be executed on one match system and the hedge transaction may be executed on another match system.

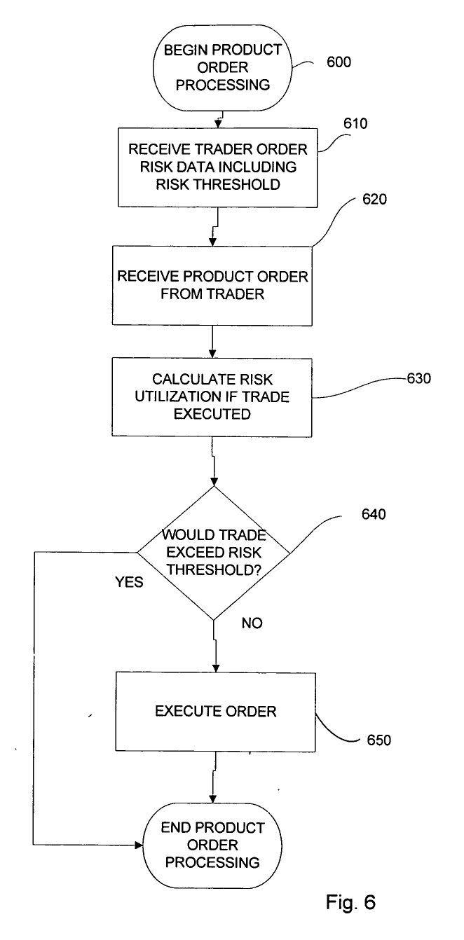

In other embodiments of the invention, as shown in FIG. 6, a method of processing derivative product orders at an exchange 600 is provided which takes into account a trader's order risk. The exchange may track a trader's order risk measured by a given parameter incurred through one or more trades, which may be called a trader's “order risk parameter utilization state or value.” The exchange may use this order risk parameter utilization state or value to determine when execution of an order would cause an order risk threshold to be exceeded. The method includes receiving derivative product order risk data for a trader 610 including at least one threshold value corresponding to at least one order risk parameter; receiving from the trader an order for a derivative product 620; utilizing the derivative product order and the trader's current order risk parameter utilization state to calculate risk utilization 630; and processing the derivative product order such that the order risk threshold is not crossed 640, 650. For example, in one embodiment of the present invention, the order risk data may include the volume of trades that can be made and the order risk parameter may be a maximum volume threshold. The order risk data may be provided with the derivative product orders or may be provided separately and maintained in a database at the exchange or match system. When trades have been made whose volume equals the volume threshold, all outstanding orders for the trader within a category of trades are cancelled by the system. This may be called “one cancels other” or “OCO” which means that execution of one order causing a threshold to be met or exceeded causes all other orders in a particular category to be cancelled. In some embodiments, only a portion of an order may be executed before the risk threshold is reached and the balance of the order is cancelled. In specific embodiments of the invention, the trader's order may be a variable product order.

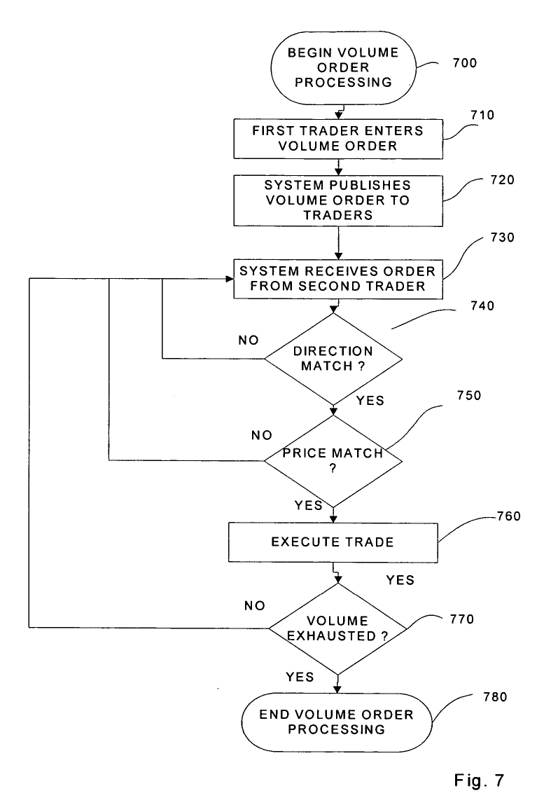

In another embodiment of the invention, a method for trading a large volume order (“LVO”) of a security, such as a derivative, is provided. This method can advantageously permit an LVO to be transacted in a market without substantially moving the market. As shown in FIG. 7, a first trader enters 710 an LVO at a match system (the “entered LVO”). The entered LVO specifies a security, a direction of trading (i.e., buy or sell), a volume and a limit price. The system publishes 720 the LVO to a plurality of potential traders (the “published LVO”), but the trader may choose to publish the LVO without publishing one or more of the specified price, the specified volume or the specified direction. A second trader may respond to the published LVO by entering 730 an order specifying to the match system: a direction of trading, a volume and a price. The match system will execute 760 the trade when the second trader's order's direction of trading 740 matches the direction of trading for the entered LVO and the price is consistent 750 with the limit price in the entered LVO. A price is consistent with the limit price if the second trader's price is not less than the limit price when the direction of the second order corresponds to an order to buy the security and the second price is not greater than the limit price when the direction of the second order corresponds to an order to sell the security. When the trade has been made, the system may publish a trading report that specifies the trade. If the volume of the trade is less 770 than the volume specified in the entered LVO, the system may continue to publish the volume order to the plurality of traders. The process can continue until the total volume of securities traded against the published LVO equals the volume in the entered LVO. Note that the term “large” in “large volume order” is meant to be descriptive and not intended to limit embodiments of the invention to any specific volume of a security. Further, in practice, embodiments of the invention will make allowance for any exchange rules that may incorporate a “maximum crossing facility.” For example, if a large broker has an order to buy 50,000 lots, then typically an exchange would allow the broker to legitimately cross a percentage of the order, e.g. 40%, in order to satisfy any other in-house customers.

In specific embodiments of trading LVOs, the first trader may specify in the entered LVO a minimum volume of a trade for the security. This minimum volume may not be published to the traders in the published LVO, according to the first trader's instructions. The system will execute the second trader's order only if the volume of the second trader's order is at least the minimum volume specified in the entered LVO. In other specific embodiments of the invention, the first trader specifies a time-to-live for the entered LVO. The system will automatically cancel the remaining portion of the LVO not executed by the end of the time-to-live.

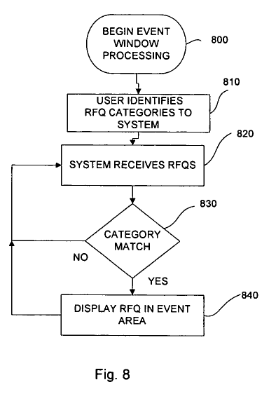

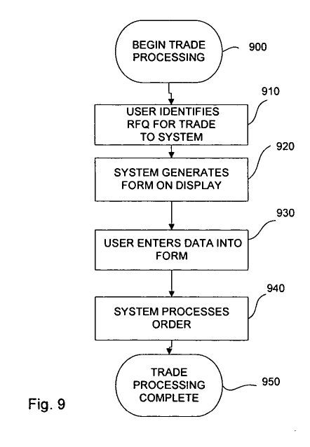

In another embodiment of the invention, as shown in FIGS. 8 and 9, a method is provided for processing 800 a user's order for a financial product. The user selects 810 one or more categories of requests for quotation (“RFQ”) for a system to display to the user in a specified display area, which may be called an event area or window. Categories of RFQs may include RFQs selected by criteria such as:
price thresholds;
expiration date;
volume threshold for a derivative;
increased volume of derivatives bid;
prices changes;
the derivative in the RFQ is part of the user's open position inventory; and
volatility level above or below a threshold.

(Note that this listing of category criteria is provided by way of example, not limitation.)

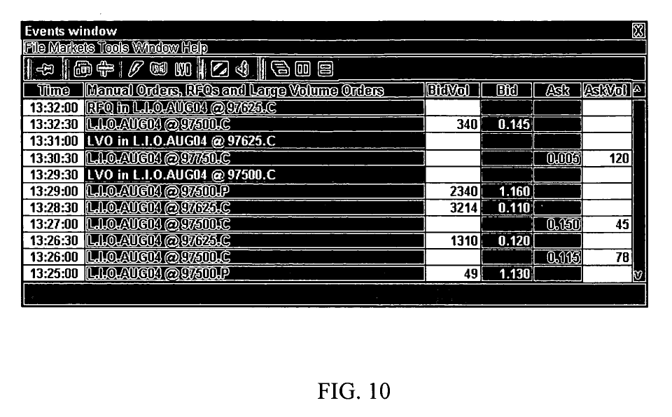

The system receives 820 RFQs and when an RFQ falls into one (or more) of the user's selected categories 830, the system displays 840 the RFQ to the user in an event area on a user display. The event area may be, for example, a display window on display systems that support windowing capability. The event area may be displayed on a user's PDA or cell phone or any other electronic display device. Display of RFQs matching user selected criteria in a special area permit a user to focus on RFQs of high interest. Thus, the user can avoid monitoring manually every one of a potentially large number of display screens or areas that show all RFQs. After the system highlights an RFQ in an event area, as shown in FIG. 8, the user may select 910 any of the highlighted RFQs in the event area. This selection can be made, for example, by activating a pointing device such as a mouse or trackball identifying the RFQ. When the user selects an RFQ, the system presents 920 the user with a form or “ticket” on the display. The user enters information 930 into the form that is relevant to an order for the derivative product and then notifies the system that the order is ready for processing. The system may then process 940 the order based on the information in the form. In various embodiments, the user may enter changes to the categories of RFQs to be displayed in the event area. Thereafter, RFQs displayed will match the updated categories. While these RFQs may be for derivative products, the method is equally applicable for any financial instrument or security. FIG. 10 shows an exemplary event window according to an embodiment of this invention, containing pointers to RFQs. Positioning a mouse pointer on an RFQ row (the first row in the window display) and activating the mouse causes order tickets to appear superimposed on the event window. The user may enter an order by filling in the fields of the order ticket and submitting the ticket to the system. This method of entering orders for RFQs of high interest can advantageously greatly reduce the time needed to identify trading opportunities and respond accordingly.

In a specific embodiment of the invention, the system may send the received order, based on the information entered by the user into the form or ticket to a second system for processing.

It should be noted that the flow diagrams are used herein to demonstrate various aspects of the invention, and should not be construed to limit the present invention to any particular logic flow or logic implementation. The described logic may be partitioned into different logic blocks (e.g., programs, modules, functions, or subroutines) without changing the overall results or otherwise departing from the true scope of the invention. Oftentimes, logic elements may be added, modified, omitted, performed in a different order, or implemented using different logic constructs without changing the overall results or otherwise departing from the true scope of the invention.

The present invention may be embodied in many different forms, including, but in no way limited to, computer program logic for use with a processor (e.g., a microprocessor, microcontroller, digital signal processor, or general purpose computer), programmable logic for use with a programmable logic device (e.g., a Field Programmable Gate Array (FPGA) or other PLD), discrete components, integrated circuitry (e.g., an Application Specific Integrated Circuit (ASIC)), or any other means including any combination thereof.

Computer program logic implementing all or part of the functionality previously described herein may be embodied in various forms, including, but in no way limited to, a source code form, a computer exec structure form, and various intermediate forms (e.g., forms generated by an assembler, compiler, linker, or locator.) Source code may include a series of computer program instructions implemented in any of various programming languages (e.g., an object code, an assembly language, or a high-level language such as FORTRAN, C, C++, JAVA, or HTML) for use with various operating systems or operating environments. The source code may define and use various data structures and communication messages. The source code may be in a computer execustructure form (e.g., via an interpreter), or the source code may be converted (e.g., via a translator, assembler, or compiler) into a computer executable structure form.

The computer program may be fixed in any form (e.g., source code form, computer execustructure form, or an intermediate form) either permanently or transitorily in a tangible storage medium, such as a semiconductor memory device (e.g., a RAM, ROM, PROM, EEPROM, or Flash-Programmable RAM), a magnetic memory device (e.g., a diskette or fixed disk), an optical memory device (e.g., a CD-ROM), a PC card (e.g., PCMCIA card), or other memory device. The computer program may be fixed in any form in a signal that is transmittable to a computer using any of various communication technologies, including, but in no way limited to, analog technologies, digital technologies, optical technologies, wireless technologies, networking technologies, and internetworking technologies. The computer program may be distributed in any form as a removable storage medium with accompanying printed or electronic documentation (e.g., shrink wrapped software or a magnetic tape), preloaded with a computer system (e.g., on system ROM or fixed disk), or distributed from a server or electronic bulletin board over the communication system (e.g., the Internet or World Wide Web.)

Hardware logic (including programmable logic for use with a programmable logic device) implementing all or part of the finctionality previously described herein may be designed using traditional manual methods, or may be designed, captured, simulated, or documented electronically using various tools, such as Computer Aided Design (CAD), a hardware description language (e.g., VHDL or AHDL), or a PLD programming language (e.g., PALASM, ABEL, or CUPL.)

The present invention may be embodied in other specific forms without departing from the true scope of the invention. The described embodiments are to be considered in all respects only as illustrative and not restrictive. The term “user” and “trader” are used interchangeably within this specification and the appended claims. Similarly, the term “exchange” has been used generically to denote a system or organization for matching and executing orders for financial products and is intended to be equivalent to the term “match system.” Other variations and modifications of the embodiments described above as will be apparent to those skilled in the art are intended to be within the scope of the present invention as defined in the appended claims.

What is claimed is:

1. A method of dynamically determining a price for an order for a derivative product at an exchange, comprising: (a) receiving at an exchange a variable priced order for a derivative product, where the variable priced order comprises a derivative product identifier, an underlying product identifier, an original order price and at least one price determination variable value; and (b) determining a price for the order as a function of the original order price, an updated price of the underlying product and the at least one price determination variable value based on a predetermined formula.

2. The method of claim 1 further comprising: (c) periodically determining a price for the order based on the predetermined formula and a more recent price for the underlying product.

3. The method of claim 1 where the at least one price determination variable value includes values for a delta variable and a gamma variable and the predetermined formula comprises: Change in price of the order=chgUnderlyingprice*delta+(1/2(chgUnderlyingpriceˆ2*gamma))where chgunderlyingprice is the change in price of the underlying product.

4. A method of processing a variable derivative product order at an exchange, the method comprising: (a) receiving at the exchange the variable derivative product order that includes a price that is a function of at least one price determination variable; (b) calculating a trading price from the function; and (c) executing a trade based on the calculated trading price.

5. The method of claim 4, wherein the at least one price determination variable includes delta, which is the rate of change of the price of a derivative product with the price of an underlying product.

6. The method of claim 5, wherein the at least one price determination variable includes gamma, which is the rate of change of delta with respect to the contract price.

7. The method of claim 4, wherein (b) comprises adding a derivative product change price to an original derivative product price, the derivative product change price=ChgUnderlyingPrice*delta+(1/2(ChgUnderlyingPriceˆ2*gamma)),wherein ChgUnderlyingPrice is the change in the underlying price.

8. The method of claim 4, further including: (d) executing a hedge transaction at the time of executing the trade.

9. The method of claim 8, wherein the hedge transaction comprises buying or selling an underlying derivative.

10. The method of claim 8, wherein (d) includes locating a bid or offer for the underlying derivative.

11. The method of claim 8, wherein information for the hedge transaction is included in the variable derivative product order.

12. The method of claim 4, wherein (b) comprises using a formula supplied by the exchange.

13. The method of claim 4, wherein (b) comprises using price determination variables supplied by the user.

14. The method of claim 4, wherein the variable derivative product order is a bid.

15. The method of claim 4, wherein the variable derivative product order is an offer.

16. A method of distributing variable derivative product order information, the method comprising: (a) receiving from a first plurality of users variable derivative product order that are a function of at least one value of at least one underlying product; and (b) transmitting to a second plurality of users derivative prices based on the at least one value of the at least one underlying product.

17. The method of claim 16, wherein the first plurality of users is the same as the second plurality of users.

18. A method of trading a derivative product contract, the method comprising: (a) establishing a variable derivative product order price that is a function of a preset formula and user supplied price determination variable values; and (b) providing to an exchange the variable derivative product order.

19. The method of claim 18, wherein variable derivative product order price is a function of delta, which is the rate of change of the price of a derivative product with the price of an underlying contract.

20. The method of claim 19, wherein variable derivative product order price is a function of gamma, which is the rate of change of delta with respect to the contract price.

21. The method of claim 18, wherein (a) comprises adding a derivative product change price to an original derivative product price, the derivative product change price=ChgUnderlyingPrice*delta+(1/2(ChgUnderlyingPriceˆ2*gamma)),wherein ChgUnderlyingPrice is the change in the underlying price.

22. A computer-readable medium containing computer-executable instructions for causing a trading computer to perform the steps comprising: (a) establishing a variable derivative product order price that is a function of a preset formula and user supplied values of price determination variables; and (b) providing to an exchange the variable derivative product order.

23. A method of hedging risks associated with the purchase of a variable defined derivative product, the method comprising: (a) executing at a match system a variable defined derivative product order; (b) receiving order risk data from an order risk management module; (c) using a best efforts approach to locate a potential hedge transaction that corresponds to the derivative product order; (d) comparing data of the potential hedge transaction to the order risk data; and (e) executing the potential hedge transaction when a rule is not violated.

24. The method of claim 23, wherein (a) comprises calculating a price of the derivative product order.

25. The method of claim 24, wherein the price of the derivative product is a function of an original order price, an updated price of an underlying product and at least one price determination variable value based on a predetermined formula.

26. The method of claim 25, wherein the at least one price determination variable value includes values for a delta variable and a gamma variable and the predetermined formula comprises: Change in price of the order=ChgUnderlyingPrice*delta+(1/2(ChgUnderlyingPriceˆ2*gamma)) where ChgUnderlyingPrice is the change in price of the underlying product, delta is the rate of change of the price of the derivative product with the price of the underlying product and gamma is the rate of change of delta with respect to the derivative product price.

27. The method of claim 23, wherein the order risk data comprises a value of delta.

28. The method of claim 23, wherein (c) comprises using a match system that is different than the match system used in (a).

29. The method of claim 23, wherein the derivative product comprises an options contract and the hedge product comprises a futures contract.

30. The method of claim 23, wherein information for the hedge product transaction is included in an order for the variable defined derivative product.

31. The method of claim 23, wherein the rule in (e) requires that the order risk data not be exceeded after the potential hedge transaction.

32. The method of claim 23, wherein the rule in (e) requires that the order risk data not be exceeded before the potential hedge transaction.

33. The method of claim 23, wherein the potential hedge transaction includes a plurality of contracts and (e) comprises: (i) identifying the lowest number of the contracts that will cause the order risk threshold to be exceeded; and (ii) executing a transaction that includes the number of contracts identified in (i).

34. A method of executing a variable derivative product order that is contingent on the existence of a corresponding hedge transaction, the method comprising: (a) receiving at a match system a variable defined order for a derivative product, where the variable defined order comprises a derivative product identifier, an underlying product identifier and at least one price determination variable; (b) identifying a potential derivative product transaction; (c) searching for a hedge product transaction that corresponds to the potential derivative product transaction; and (d) executing the derivative product transaction only when a hedge transaction is available.

35. The method of claim 34, further including (i) calculating a price of the derivative product order.

36. The method of claim 35, wherein (i) comprises using a formula supplied by the match system.

37. The method of claim 35, wherein the price of the derivative product is a function of an original order price, an updated price of the underlying product and the at least one price determination variable value based on a predetermined formula.

38. The method of claim 37, wherein the at least one price determination variable value includes values for a delta variable and a gamma variable and the predetermined formula comprises: Change in price of the order=ChgUnderlyingPrice*delta+(1/2(ChgUnderlyingPriceˆ2*gamma)) where ChgUnderlyingPrice is the change in price of the underlying product, delta is the rate of change of the price of the derivative product with the price of the underlying product and gamma is the rate of change of delta with respect to the derivative product price.

39. The method of claim 34, wherein (c) comprises searching for the hedge product transaction on the same match system as the match system used for the derivative product transaction.

40. The method of claim 34, wherein the hedge transaction and derivative product transaction are both locked in before either transaction is executed.

41. The method of claim 34, wherein the derivative product comprises an options contract and the hedge product comprises a futures contract.

42. The method of claim 34, wherein information for the hedge product transaction is included in the variable defined derivative product order.

43. A computer-readable medium containing computer-executable instructions for causing a match system to perform the steps comprising: (a) receiving a variable defined order for a derivative product, where the variable defined order comprises a derivative product identifier, an underlying product identifier and at least one price determination variable; (b) identifying a potential derivative product transaction; (c) searching for a hedge product transaction that corresponds to the potential derivative product transaction; and (d) executing the derivative product transaction only when a hedge transaction is available.

44. A computer-readable medium containing computer-executable instructions for causing a match system to perform the steps comprising: (a) executing a variable defined derivative product order; (b) receiving order risk data from an order risk management module; (c) using a best efforts approach to locate a potential hedge transaction that corresponds to the derivative product order; (d) comparing data of the potential hedge transaction to the order risk data; and (e) executing the potential hedge transaction when the order risk data is not exceeded.

45. A computer-readable medium containing computer-executable instructions for causing a match system to perform the steps comprising: (a) executing a variable defined derivative product order; (b) receiving order risk data from an order risk management module; (c) using a best efforts approach to locate a potential hedge transaction that corresponds to the derivative product order; (d) comparing data of the potential hedge transaction to the order risk data; and (e) executing the potential hedge transaction up to a limit amount of risk.

46. A method of processing derivative product orders at an exchange, the method comprising: (a) receiving derivative product order risk data including at least one threshold value corresponding to at least one order risk parameter; (b) receiving from a trader an order for a derivative product; (c) utilizing the derivative product order and a trader's current order risk utilization state to calculate utilization data; and (d) processing the derivative product order in a manner determined by the derivative product order risk data and the utilization data.

47. The method of claim 46, wherein (d) comprises executing a portion of the derivative product order.

48. The method of claim 47, wherein the portion of the derivative product order includes the maximum number of contracts that do not cause the utilization data to exceed the threshold value.

49. The method of claim 47, wherein the portion of the derivative product order includes the maximum number of trading units that do not cause the utilization data to exceed the threshold value.

50. The method of claim 46, wherein the derivative product order comprises a variable defined derivative product order.

51. A method of processing derivative product orders at an exchange, the method comprising: (a) receiving derivative product order risk data including at least one threshold value corresponding to at least one order risk parameter; (b) receiving from a trader an order for a derivative product; (c) determining a trader's current order risk parameter utilization value; and (d) executing the derivative product order when the trader's current order risk parameter utilization value does not exceed the threshold value.

52. A computer-readable medium containing computer-executable instructions for causing a match system to perform the steps comprising: (a) receiving derivative product order risk data including at least one threshold value corresponding to at least one order risk parameter; (b) receiving from a trader an order for a derivative product; (c) utilizing the derivative product order and a trader's current order risk utilization state to calculate utilization data; and (d) processing the derivative product order in a manner determined by the derivative product order risk data and the utilization data.

53. A computer-readable medium containing computer-executable instructions for causing a match system to perform the steps comprising: (a) receiving derivative product order risk data including at least one threshold value corresponding to at least one order risk parameter; (b) receiving from a trader an order for a derivative product; (c) determining a trader's current order risk parameter utilization value; and (d) executing the derivative product order when the trader's current order risk parameter utilization value does not exceed the threshold value.
